(19) United States
(12) Patent Application Publication
(10) Pub. No.: US 2022/0134516 A1
(43) Pub. Date: May 5, 2022

(54) RATCHET WRENCH HANDLE

(71) Applicant: KO-KEN TOOL CO., LTD., Shizuoka-Pref. (JP)

(72) Inventor: Takamichi NAITO, Shizuoka-Pref. (JP)

(21) Appl. No.: 17/510,792

(22) Filed: Oct. 26, 2021

(30) Foreign Application Priority Data
Oct. 30, 2020 (JP) 2020-182236

(51) Int. Cl. B25B 13/46

(52) U.S. Cl. CPC B25B 13/463

(57) ABSTRACT

In order to provide a ratchet wrench handle A that can be used with a reduced swing width of the handle without reducing the torque at the time of rotating a tool, the operation piece 9 is composed of two partial members, i.e., a claw member 9a and a receiving member 9b; and when an adapter t is rotated in the positive direction, with a positive rotation-aimed operation teeth 9a1 of the claw member 9a engaged with ratchet teeth 6 of a rotation member 3, a wedge effect given by the positive rotation-aimed operation teeth 9a1 of the claw member 9a and a claw member's first positive rotation-aimed sloping face 9a3 of the claw member 9a makes the rotation member 3 stop its rotation, which allows the adapter t to be rotated in the positive direction.

### BACKGROUND OF THE INVENTION

### Field of the Invention

The present invention relates to a ratchet wrench handle for fastening and loosening a bolt, with an adapter (a socket) assembled to a rotation member provided at the handle head.

### Description of the Related Art

There has been known a ratchet wrench handle for fastening and loosening a bolt, with an adapter assembled to a rotation member provided at the handle head, as shown, for example, by FIG. 10 as a ratchet wrench handle A′ (see Prior Art Document 1 as mentioned below).
Prior Art Document 1: Japanese Patent No. 5568273

### SUMMARY OF THE INVENTION

### Problem to be Solved by the Invention

However, the ratchet wrench handle A′ according to the aforesaid Prior Art Document 1 is provided with a fairly small number of ratchet teeth, for example, 36 ratchet teeth. Thus, as shown in FIG. 6 that will be described in detail later, in order for one convex of the ratchet teeth 6′ to go over one convex of either a positive rotation-aimed operation teeth or a reverse rotation-aimed operation teeth provided on an operation piece 9′, a handle 1′ had to be swung wide approximately 10 degrees.

Then, in the ratchet wrench handle A′ of the aforesaid Prior Art Document 1, an attempt was made to nearly double the number of convexes of the ratchet teeth 6′ of the rotation member 3′ and the number of convexes of the positive rotation-aimed operation teeth and the reverse rotation-aimed operation teeth of the operation piece 9′. However, because the ratchet wrench handle A′ of the aforesaid Prior Art Document 1 is constructed, as shown in FIG. 10, such that the rotation torque generated by the rotation member 3′ is received, via the ratchet teeth 6′, by the teeth of the operation piece 9′, and then is received by the part of the handle head 1a′ which is located closer to a switch member 14′ than an assembling bolt 10′, 36 convexes was the maximum limit; and in order to increase the number of convexes of the ratchet teeth 6′ of the rotation member 3′ and the number of convexes of the positive rotation-aimed operation teeth and the reverse rotation-aimed operation teeth of the operation piece 9′, it was required that each convex be made much smaller, which caused another problem that the ratchet teeth 6′ of the rotation member 3′ and the positive/reverse rotation-aimed operation teeth of the operation piece 9′ slide over each other.

The present invention has been made in view of the above-mentioned problems, and an object of the present invention is to provide a ratchet wrench handle that can be used with a reduced swing width of the handle without reducing the torque at the time of rotating a tool and without increasing the size of the handle head, thereby realizing higher efficiency, quality and workability than the conventional one.

### Means to Solve the Problems

In order to solve the above-mentioned problems, a ratchet wrench handle according to one embodiment of the present invention comprises: a rotation member disposed at a handle head located at a distal end of an operation handle and provided with a portion for attaching an adapter, and an operation piece provided with positive rotation-aimed operation teeth and reverse rotation-aimed operation teeth, said rotation member being further provided with ratchet teeth continuously formed on a periphery of the rotation member to engage, through operating a switch member, with either one side chosen between the positive rotation-aimed operation teeth and the reverse rotation-aimed operation teeth provided on the operation piece, thereby to rotate the operation handle in the positive or reverse direction; wherein the operation piece is composed of two partial members, i.e., a claw member provided, on the ratchet teeth side thereof, with the positive rotation-aimed operation teeth and the reverse rotation-aimed operation teeth that face and engage with the ratchet teeth, and a receiving member rotatably mounted on the handle head via an assembling bolt such that the receiving member is provided with a cam edge to engage with the switch member and abuts the switch member side of the claw member by applying the side of the receiving member which is located opposite to the cam edge, with the assembling bolt therebetween; the claw member is provided, on its switch member side which is the side of the claw member opposite the positive rotation-aimed operation teeth and the reverse rotation-aimed operation teeth, with a claw member's positive rotation-aimed sloping face and a claw member's reverse rotation-aimed sloping face that are opposite to the positive rotation-aimed operation teeth and the reverse rotation-aimed operation teeth respectively such that the claw member's positive rotation-aimed sloping face and the claw member's reverse rotation-aimed sloping face are formed to slope down in such a manner that the distance between the range of the claw member's positive rotation-aimed sloping face and the claw member's reverse rotation-aimed sloping face and the range of the positive rotation-aimed operation teeth and the reverse rotation-aimed operation teeth is gradually increased as those sloping faces go away from the center of the claw member respectively; and the receiving member 9b is provided, on its claw member side, with a receiving member's positive rotation-aimed sloping face and a receiving member's reverse rotation-aimed sloping face that abut the claw member's positive rotation-aimed sloping face and the claw member's reverse rotation-aimed sloping face respectively when the operation handle is rotated in the positive or reverse direction.

Besides, in the ratchet wrench handle according to the present invention, the claw member is further provided, on its switch member side and at the same time, on its claw member's positive rotation-aimed sloping face side, with a claw member's reverse idling rotation-time pressing face for pressing the receiving member, thereby to idle the claw member and the receiving member as one body when the operation handle idles in the reverse direction. On the other hand, the claw member is further provided, on its switch member side and at the same time, on its claw member's reverse rotation-aimed sloping face side, with a claw member's positive idling rotation-time pressing face for pressing a receiving member, thereby to idle the claw member and the receiving member as one body when the operation handle idles in the positive direction. The receiving member is further provided, on its claw member side and at the same time, on its receiving member's positive rotation-aimed sloping face side, with a receiving member's reverse idling rotation-time pressing face to be pressed by the claw member's reverse idling rotation-time pressing face, thereby to idle the claw member and the receiving member as one body when the operation handle idles in the reverse direction. On the other hand, the receiving member is further provided, on its claw member side and at the same time, on its receiving member's reverse rotation-aimed sloping face side, with a receiving member's positive idling rotation-time pressing face to be pressed by the claw member's positive idling rotation-time pressing face thereby to idle the claw member and the receiving member as one body when the operation handle idles in the positive direction.

Furthermore, an angle formed between the claw member's positive rotation-aimed sloping face and the claw member's reverse idling rotation-time pressing face, an angle formed between the claw member's reverse rotation-aimed sloping face and the claw member's positive idling rotation-time pressing face, an angle formed between the receiving member's positive rotation-aimed sloping face and the receiving member's reverse idling-time pressing face, and an angle formed between the receiving member's reverse rotation-aimed sloping face and the receiving member's positive rotation-time pressing face are each an obtuse angle larger than 90 degrees and smaller than 180 degrees.

Moreover, the claw member's positive rotation-aimed sloping face is divided by the claw member's reverse idling rotation-time pressing face into two parts; the claw member's reverse rotation-aimed sloping face is divided by the claw member's positive idling rotation-time pressing face into two parts; the receiving member's positive rotation-aimed sloping face is divided by the receiving member's reverse idling rotation-time pressing face into two parts; and the receiving member's reverse rotation-aimed sloping face is divided by the receiving member's positive idling rotation-time pressing face into two parts. The divided claw member's positive rotation-aimed sloping face, claw member's reverse rotation-aimed sloping face, receiving member's positive rotation-aimed sloping face and receiving member's reverse rotation-aimed sloping face are formed such that the sloping face located at an outer position than each of the claw member's reverse idling rotation-time pressing face, the claw member's positive idling rotation-time pressing face, the receiving member's reverse idling rotation-time pressing face and the receiving member's positive idling rotation-time pressing face has an inclination angle closer to the horizontal than the sloping face located at an inner position than each of the aforesaid pressing faces.

### Advantageous Effects of the Invention

In a ratchet wrench handle according to the present invention, the operation piece is composed of two partial members, i.e., a claw member provided, on the ratchet teeth side thereof, with the positive rotation-aimed operation teeth and the reverse rotation-aimed operation teeth that face and engage with the ratchet teeth, and a receiving member rotatably mounted on the handle head via an assembling bolt such that the receiving member is provided with a cam edge to engage with the switch member and abuts the switch member side of the claw member by applying the side of the receiving member which is located opposite to the cam edge, over the assembling bolt located therebetween; and the claw member is provided, on its switch member side which is the side of the claw member opposite the positive rotation-aimed operation teeth and the reverse rotation-aimed operation teeth, with a claw member's positive rotation-aimed sloping face and a claw member's reverse rotation-aimed sloping face that are opposite to the positive rotation-aimed operation teeth and the reverse rotation-aimed operation teeth respectively such that the claw member's positive rotation-aimed sloping face and the claw member's reverse rotation-aimed sloping face are formed to slope down in such a manner that the distance between the range of the claw member's positive rotation-aimed sloping face and the claw member's reverse rotation-aimed sloping face and the range of the positive rotation-aimed operation teeth and the reverse rotation-aimed operation teeth is gradually widened as those sloping faces go away from the center of the claw member respectively; and the receiving member is provided, on its claw member side, with a receiving member's positive rotation-aimed sloping face and a receiving member's reverse rotation-aimed sloping face that abut the claw member's positive rotation-aimed sloping face and the claw member's reverse rotation-aimed sloping face respectively when the operation handle is rotated in the positive and reverse directions.

Therefore, when an adapter is to be rotated in the positive direction, with the positive rotation-aimed operation teeth of the claw member engaged with the ratchet teeth of the rotation member, a wedge effect generated by the positive rotation-aimed operation teeth of the claw member and the claw member's positive rotation-aimed sloping face of the claw member makes the rotation member stop its rotation, which allows the adapter t to be rotated in the positive direction. On the other hand, when an adapter is to be rotated in the reverse direction, with the reverse rotation-aimed operation teeth of the claw member engaged with the ratchet teeth of the rotation member, a wedge effect generated by the reverse rotation-aimed operation teeth of the claw member and the claw member's reverse rotation-aimed sloping face of the claw member makes the rotation member stop its rotation, which allows the adapter to be rotated in the reverse direction.

Thus, in the present invention, because the torque at the time of rotating the tool is received, via the ratchet teeth of the rotation member, by the operation piece composed of two partial members, i.e., the claw member and the receiving member, thereby transmitting the rotation torque to the part of the handle head closer to the switch member than the assembling bolt, the adapter can be rotated without reducing the torque at the time of rotating the tool and without increasing the size of the handle head.

Furthermore, because the operation piece is composed of the two partial members, i.e., the claw member and the receiving member, a wedge effect generated by a pair of the positive rotation-aimed operation teeth of the claw member and the claw member's positive rotation-aimed sloping face or by a pair of the reverse rotation-aimed operation teeth of the claw member and claw member's reverse rotation-aimed sloping face makes the rotation member stop its rotation, thereby rotating the adapter in the positive and reverse directions. Thus, increase of the number of convexes of the ratchet teeth, the positive rotation-aimed operation teeth and the reverse rotation-aimed operation teeth does not cause slippage, and besides, the reduced swing width of the handle provides a high efficiency and high quality ratchet wrench handle, improving workability.

### BRIEF DESCRIPTION OF THE DRAWINGS

FIG. 1 is a front view of an unveiled main section of a ratchet wrench handle according to one embodiment of the present invention.

FIG. 2 is a cross-sectional view taken along line a-a indicated in FIG. 1.

FIG. 3 is a cross-sectional view of the ratchet wrench handle in the state of being disassembled according to one embodiment of the present invention.

FIG. 4A and FIG. 4B respectively show plan views of a claw member and a receiving member that collaboratively form an operation piece of the ratchet wrench handle according to one embodiment of the present invention.

FIG. 5 is a front view of an unveiled main section of the ratchet wrench handle in the locked state at the time of positive rotation according to one embodiment of the present invention.

FIG. 6 is an explanatory view showing a rotation angle of an operation handle required to go over one convex of a ratchet teeth of a rotation member in the conventional ratchet wrench handle disclosed by the Prior Art Document 1.

FIG. 7 is an explanatory view showing a rotation angle of an operation handle required to go over one convex of ratchet teeth of a rotation member in the ratchet wrench handle according to one embodiment of the present invention.

FIG. 8 shows directions of the rotation torque transmitted from the rotation member to a handle head by way of the claw member and the receiving member at the time of positive rotation of the ratchet wrench handle according to one embodiment of the present invention.

FIG. 9 is a front view of an unveiled main section of the ratchet wrench handle according to one embodiment of the present invention, wherein a switch member is switched to the reverse position to rotate a tool at the time of reverse rotation.

FIG. 10 shows the construction of the conventional ratchet wrench handle recited in the Prior Art Document 1.

### DETAILED DESCRIPTION OF THE PREFERRED EMBODIMENTS

Next, one preferred embodiment of a ratchet wrench handle A according to the present invention will be described with reference to the accompanying drawings. The under-described embodiment is only one example of the present invention, and the present invention is not limited thereto, and can be altered appropriately within the range of the technical idea of the present invention. Particularly, the following description refers to the number of convexes of ratchet teeth 6 of a rotation member 3 as 72 which is twice as many as that of the conventional one. However, this is just an example, and the number of convexes of the ratchet teeth 6 can also be, for example, 60 which is a smaller number than 72; 90 or 108 which is a larger number than 72; or other appropriate numbers. These numbers are, of course, included in the range of the present invention.

The fundamental construction of a ratchet wrench handle A according to one embodiment of the present invention is the same as that of the ratchet wrench handle disclosed by the aforesaid Prior Art Document 1, Japanese Patent No. 5568273 that the present applicant previously obtained, except for the number of convexes of the ratchet teeth of the rotation member 3 and the construction of an operation piece 9. Thus, the construction and operation of each of the rotation member 3 and the operation piece 9, which are different from those of the ratchet wrench handle disclosed by the Japanese Patent No. 5568273, will mainly be described hereafter.

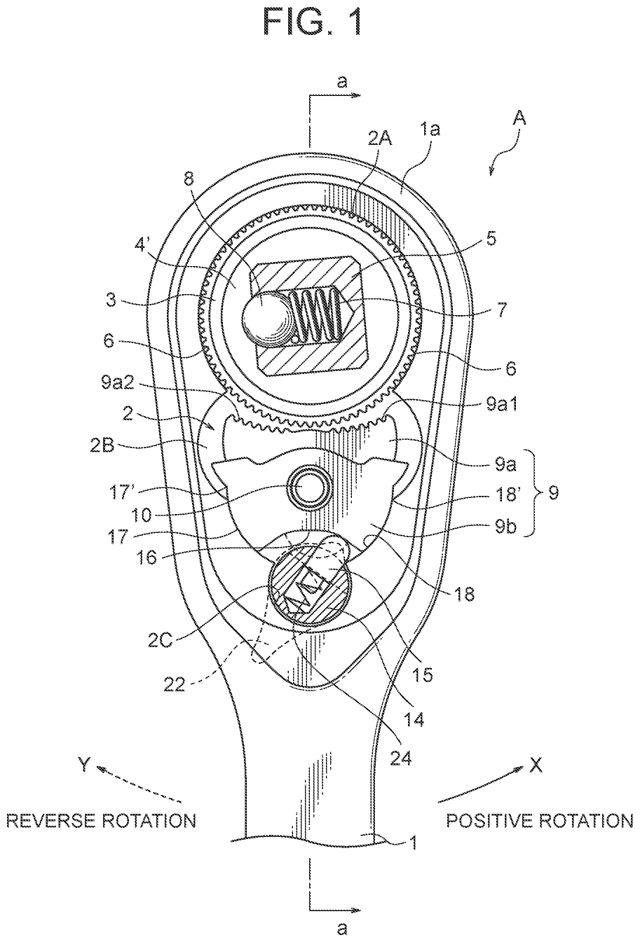

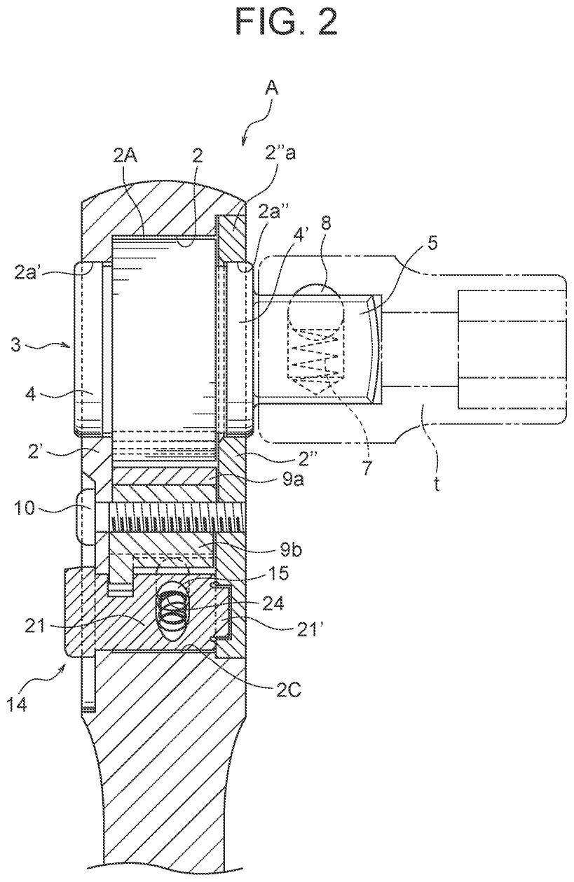

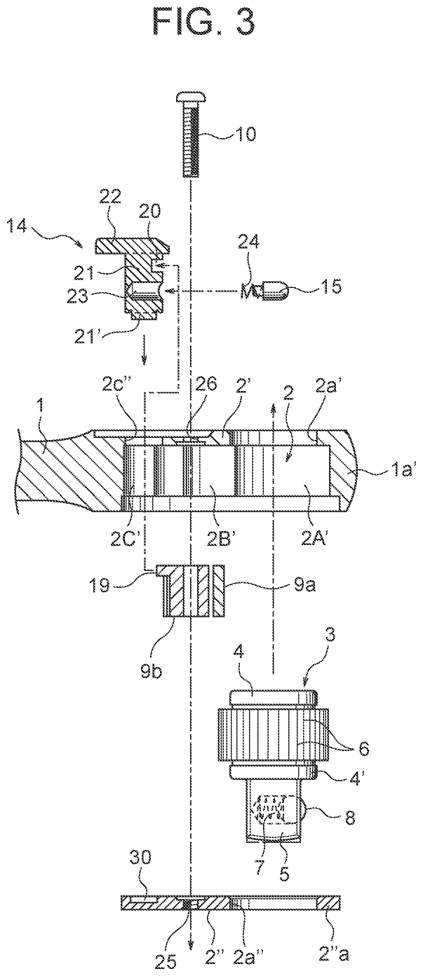

As shown by FIGS. 1 to 3, a ratchet wrench handle A according to one embodiment of the present invention comprises: a rotation member 3 disposed at a handle head 1a located at a distal end of an operation handle 1 and provided with a portion for attaching an adapter t, and an operation piece 9 provided with positive rotation-aimed operation teeth 9a1 and reverse rotation-aimed operation teeth 9a2, said rotation member 3 being further provided with ratchet teeth 6 continuously formed on a periphery of the rotation member 3 to engage, through operating a switch member 14, with either one side chosen between the positive rotation-aimed operation teeth 9a1 and the reverse rotation-aimed operation teeth 9a2 provided on the operation piece 9, thereby to rotate the adapter t in a positive or reverse direction. However, unlike the ratchet wrench handle disclosed by the aforesaid Prior Art Document 1, Japanese Patent No. 5568273, the present invention is characterized in that the number of convexes of the ratchet teeth 6 continuously formed on the periphery of said rotation member 3 is doubled from 36 to 72, and accordingly, the number of covexes of the positive rotation-aimed operation teeth 9a1 and the reverse rotation-aimed operation teeth 9a2 is also doubled; and the operation piece 9 is not constructed as one single member, but is composed of two partial members, i.e., a claw member 9a and a receiving member 9b. A collar 11, which was provided on the periphery of an assembling bolt 10 in the aforesaid Prior Art Document 1, Japanese Patent No. 5568273, is omitted.

### (An Operation Piece 9)

As shown by FIGS. 1 to 3, the operation piece 9 is composed of two partial members, i.e., a claw member 9a forming the upper part (i.e., the ratchet teeth 6 side) of the operation piece 9 and provided, on the ratchet teeth 6 side thereof, with positive rotation-aimed operation teeth 9a1 and reverse rotation-aimed operation teeth 9a2 that face and engage with the ratchet teeth 6; and a receiving member 9b that is provided with a cam edge 16 to engage with a switch member 14 and abuts the switch member 14 side of the claw member 9a by applying the side of the receiving member 9b which is located opposite to the cam edge, over the assembling bolt located therebetween.

### (A Claw Member 9a)

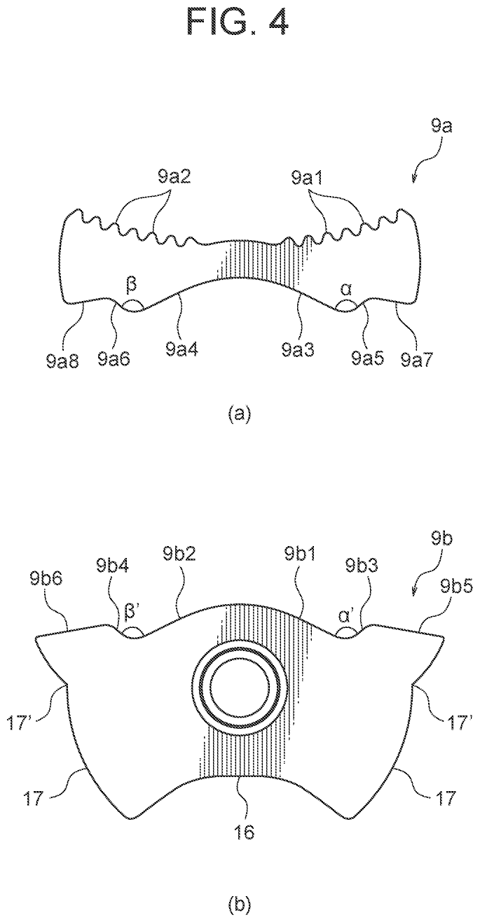

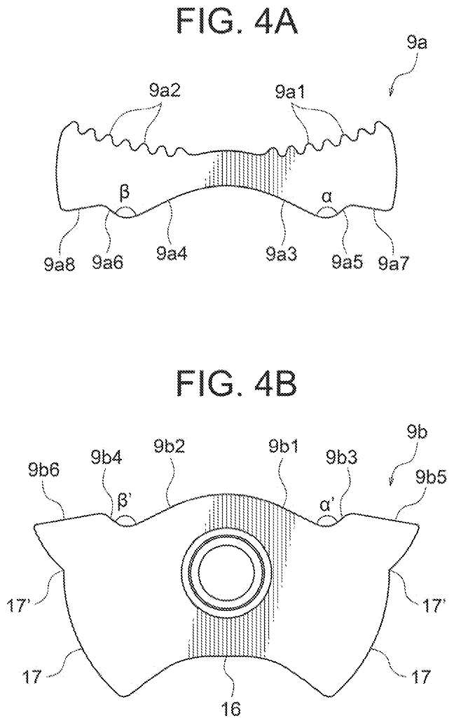

As shown by FIG. 4A, a claw member 9a is provided, on its upper side as seen in the Figure, with positive rotation-aimed operation teeth 9a1 and reverse rotation-aimed operation teeth 9a2 to engage with the ratchet teeth 6 continuously formed on a periphery of said rotation member 3, and on its lower side as seen in the Figure (i.e., on its switch member 14 side which is the side of the claw member 9a opposite the positive rotation-aimed operation teeth 9a1 and the reverse rotation-aimed operation teeth 9a2), with a claw member's first positive rotation-aimed sloping face 9a3 and a claw member's first reverse rotation-aimed sloping face 9a4 that are opposite to the positive rotation-aimed operation teeth 9a1 and the reverse rotation-aimed operation teeth 9a2 respectively such that the claw member's first positive rotation-aimed sloping face 9a3 and the claw member's first reverse rotation-aimed sloping face 9a4 are located on the right and left sides of the lower side of the claw member 9a. The claw member's first positive rotation-aimed sloping face 9a3 and the claw member's first reverse rotation-aimed sloping face 9a4 are formed to slope down in such a manner that the distance between the range of the claw member's first positive rotation-aimed sloping face 9a3 and the claw member's first reverse rotation-aimed sloping face 9a4 and the range of the positive rotation-aimed operation teeth 9a1 and the reverse rotation-aimed operation teeth 9a2 is gradually increased as the sloping faces 9a3 and 9a4 go away from the center of the claw member 9a respectively.

The claw member 9a is further provided, on its switch member 14 side and at the same time, on its claw member's first positive rotation-aimed sloping face 9a3 side, with a claw member's reverse idling rotation-time pressing face 9a5 for pressing the receiving member 9b thereby idling the claw member 9a and the receiving member 9b as one body, when the ratchet wrench handle A idles in the reverse direction. On the other hand, the claw member 9a is further provided, on its switch member 14 side and at the same time, on its claw member's first reverse rotation-aimed sloping face 9a4 side, with a claw member's positive idling rotation-time pressing face 9a6 for pressing the receiving member 9b thereby idling the claw member 9a and the receiving member 9b as one body, when the ratchet wrench handle A idles in the positive direction.

In this respect, an angle α formed between the claw member's first positive rotation-aimed sloping face 9a3 and the claw member's reverse idling rotation-time pressing face 9a5 is an obtuse angle larger than 90 degrees and smaller than 180 degrees. Similarly, an angle β formed between the claw member's first reverse rotation-aimed sloping face 9a4 and the claw member's positive idling rotation-time pressing face 9a6 is an obtuse angle larger than 90 degrees and smaller than 180 degrees.

Furthermore, at an outer side of the claw member's reverse idling rotation-time pressing face 9a5, in other words, on the opposite side from the claw member's first positive rotation-aimed sloping face 9a3 via the claw member's reverse idling rotation-time pressing face 9a5 is provided a claw member's second positive rotation-aimed sloping face 9a7. Similarly, at an outer side of the claw member's positive idling rotation-time pressing face 9a6, in other words, on the opposite side from the claw member's first reverse rotation-aimed sloping face 9a4 via the claw member's positive idling rotation-time pressing face 9a6 is provided a claw member's second reverse rotation-aimed sloping face 9a8.

This means that the claw member's first positive rotation-aimed sloping face 9a3 and the claw member's second positive rotation-aimed sloping face 9a7 are located across from each other, with the claw member's reverse idling rotation-time pressing face 9a5 disposed between them; and on the other hand, the claw member's first reverse rotation-aimed sloping face 9a4 and the claw member's second reverse rotation-aimed sloping face 9a8 are located across from each other, with the claw member's positive idling rotation-time pressing face 9a6 disposed between them.

Even when the angle of the claw member 9a engaged with the ratchet teeth 6 of the rotation member 3 changes at the positive rotation time such as to change the angle of the claw member 9a to the receiving member 9b, in order to transmit the rotation torque, stress, etc. generated by the rotation member 3 from the claw member 9a to the receiving member 9b without fail, with the ratchet teeth 6 and the positive rotation-aimed operation teeth 9a1 surely engaged with each other without slippage, the claw member's first positive rotation-aimed sloping face 9a3 and the claw member's second positive rotation-aimed sloping face 9a7 are formed to have different inclination angles such that the inclination angle of the claw member's second positive rotation-aimed sloping face 9a7 located at the outer side is closer to the horizontal than that of the claw member's first positive rotation-aimed sloping face 9a3 located at the inner side. Similarly, in order to transmit, at the reverse rotation time, the rotation torque, stress, etc. generated by the rotation member 3 from the claw member 9a to the receiving member 9b without fail, with the ratchet teeth 6 and the positive rotation-aimed operation teeth 9a1 surely engaged with each other without slippage, the inclination angle of the claw member's second reverse rotation-aimed sloping face 9a8 located at the outer side is closer to the horizontal than that of the claw member's first reverse rotation-aimed sloping face 9a4 located at the inner side.

As shown by FIGS. 1 to 3, etc., the receiving member 9b forms a lower part of the operation piece 9, i.e., the switch member 14 side of the operation piece 9. As shown by FIG. 4, the receiving member 9b is provided, on its claw member 9a side, with a receiving member's first positive rotation-aimed sloping face 9b1 and a receiving member's first reverse rotation-aimed sloping face 9b2 that abut the claw member's first positive rotation-aimed sloping face 9a3 and the claw member's first reverse rotation-aimed sloping face 9a4 respectively when an adapter t is rotated in the positive or reverse direction. When an adapter t is rotated in the positive direction in such a manner that the positive rotation-aimed operation teeth 9a1 of the claw member 9a is engaged with the ratchet teeth 6 of the rotation member 3, a wedge effect generated by the positive rotation-aimed operation teeth 9a1 of the claw member 9a and the claw member's first positive rotation-aimed sloping face 9a3 of the claw member 9a makes the rotation member 3 stop its rotation, which allows the adapter t to be rotated in the positive direction. On the other hand, when the adapter t is rotated in the reverse direction in such a manner that the reverse rotation-aimed operation teeth 9a2 of the claw member 9a is engaged with the ratchet teeth 6 of the rotation member 3, a wedge effect generated by the reverse rotation-aimed operation teeth 9a2 of the claw member 9a and the claw member's first reverse rotation-aimed sloping face 9a4 of the claw member 9a makes the rotation member 3 stop its rotation, which allows the adapter t to be rotated in the positive direction.

The receiving member 9b is further provided, on its claw member 9a side and at the same time, on its receiving member's first positive rotation-aimed sloping face 9b1 side, with a receiving member's reverse idling rotation-time pressing face 9b3 to be pressed by the claw member's reverse idling rotation-time pressing face 9a5 thereby idling the claw member 9a and the receiving member 9b as one body, when the ratchet wrench handle A idles in the reverse direction. On the other hand, the receiving member 9b is further provided, on its claw member 9a side and at the same time, on its receiving member's first reverse rotation-aimed sloping face 9b2 side, with a receiving member's positive idling rotation-time pressing face 9b4 to be pressed by the claw member's positive idling rotation-time pressing face 9a6 thereby idling the claw member 9a and the receiving member 9b as one body, when the ratchet wrench handle A idles in the positive direction.

In this respect, an angle α′ formed between the receiving member's first positive rotation-aimed sloping face 9b1 and the receiving member's reverse idling rotation-time pressing face 9b3 is identical with an angle α formed between the claw member's first positive rotation-aimed sloping face 9a3 and the claw member's reverse idling rotation-time pressing face 9a5, and an angle β′ formed by the receiving member's first reverse rotation-aimed sloping face 9b2 and the receiving member's positive idling rotation-time pressing face 9b4 is identical with an angle formed between the claw member's first reverse rotation-aimed sloping face 9a4 and the claw member's positive idling rotation-time pressing face 9a6. Each of the angles α, α′, β and β′ is an obtuse angle larger than 90 degrees and smaller than 180 degrees.

Furthermore, at an outer side of the receiving member's reverse idling rotation-time pressing face 9b3, in other words, on the opposite side from the receiving member's first positive rotation-aimed sloping face 9b1 via the receiving member's reverse idling rotation-time pressing face 9b3 is provided a receiving member's second positive rotation-aimed sloping face 9b5. Similarly, at an outer side of the receiving member's positive idling rotation-time pressing face 9b4, in other words, on the opposite side from the receiving member's first reverse rotation-aimed sloping face 9b2 via the receiving member's positive idling rotation-time pressing face 9b4 is provided a receiving member's second reverse rotation-aimed sloping face 9b6.

Even when the angle of the claw member 9a engaged with the ratchet teeth 6 of the rotation member 3 changes at the positive rotation time such as to change the angle of the claw member 9a to the receiving member 9b, in order to transmit the rotation torque, stress, etc. generated by the rotation member 3 from the claw member 9a to the receiving member 9b without fail, with the ratchet teeth 6 and the positive rotation-aimed operation teeth 9a1 surely engaged with each other without slippage, the inclination angle of the receiving member's second positive rotation-aimed sloping face 9b5 located at the outer side is formed to be closer to the horizontal than that of the receiving member's first positive rotation-aimed sloping face 9b1 located at the inner side, just like the relationship between the inclination angle of the claw member's first positive rotation-aimed sloping face 9a3 and that of the claw member's second positive rotation-aimed sloping face 9a7. Similarly, in order to transmit, at the reverse rotation time, the rotation torque, stress, etc. generated by the rotation member 3 from the claw member 9a to the receiving member 9b without fail, with the ratchet teeth 6 and the positive rotation-aimed operation teeth 9a1 surely engaged with each other without slippage, the inclination angle of the receiving member's second reverse rotation-aimed sloping face 9b6 located at the outer side is closer to the horizontal than that of the receiving member's first reverse rotation-aimed sloping face 9b2 located at the inner side, just like the relationship between the inclination angle of the claw member's first reverse rotation-aimed sloping face 9a4 and that of the claw member's second reverse rotation-aimed sloping face 9a8.

The receiving member 9b is provided, on its lower side, i.e., on its switch member 14 side, with a cam edge 16 with which the distal end of a pressing pin 15 of the switch member 14 engages, in the same way as the Prior Art Document 1.

[symbol]

Operation of the Ratchet Wrench Handle A in a Preferred Embodiment

[symbol]

Next, the operation of a ratchet wrench handle A as formed above in a preferred embodiment will be described as follows.

### (A Locked State at the Time of Positive Rotation)

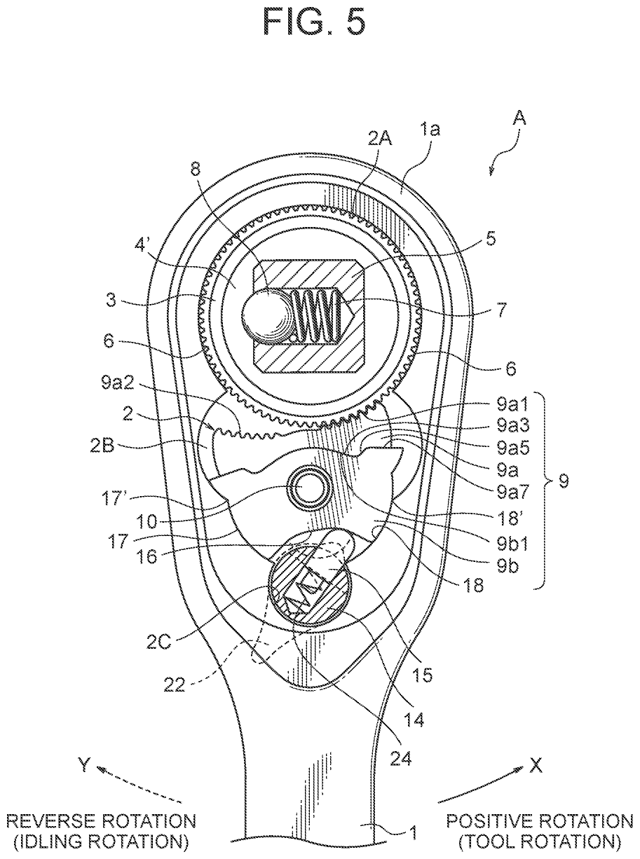

FIG. 5 shows a locked state of the ratchet wrench handle A at the time of positive rotation according to a preferred embodiment.

As shown by FIG. 5, when the pressing pin 15 of the switch member 14 is inclined to the right side in FIG. 5, the claw member 9a and the receiving member 9b that form the operation piece 9 rotate anti-clockwise about the assembling bolt 10 from the neutral state as shown in FIG. 1 until the positive rotation-aimed operation teeth 9a1 engage with the ratchet teeth 6 of the rotation member 3.

Here, unlike the ratchet wrench handle A′ disclosed by the aforesaid Prior Art Document 1, Japanese Patent No. 5568273 wherein the number of convexes of the ratchet teeth 6 is 36, a ratchet wrench handle A according to one embodiment of the present invention has increased the number of convexes of ratchet teeth 6 of the rotation member 3, for example, to the doubled number of 72, and accordingly, has also doubled the number of convexes of each of the positive rotation-aimed operation teeth 9a1 and the reverse rotation-aimed operation teeth 9a2.

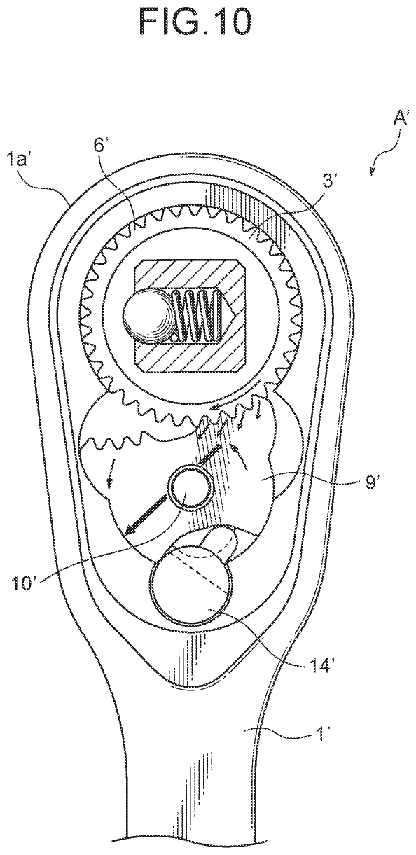

In the ratchet wrench handle A′ disclosed in the aforesaid Prior Art Document 1, wherein the operation piece 9′ is constructed as one single member, and the number of convexes of the ratchet teeth 6′ of the rotation member 3′ is 36, when the ratchet wrench handle A′ is rotated, for example 10 degrees, as shown in FIG. 10, the positive rotation-aimed operation teeth can go over one convex of the ratchet teeth 6′.

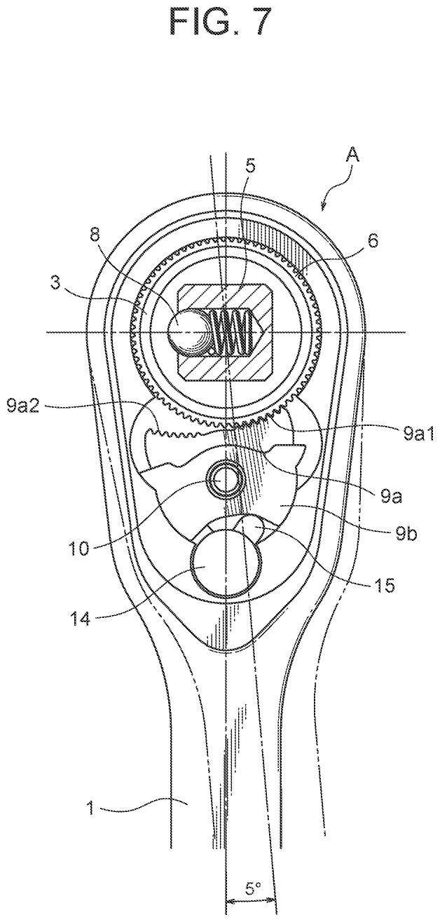

In contrast, in a ratchet wrench handle A according to one embodiment of the present invention, wherein the number of convexes of the ratchet teeth 6 of the rotation member 3 has been increased to the doubled number of 72, compared to conventional number of 36, when the ratchet wrench handle A is, as shown in FIG. 7, rotated 5 degrees, which is half of the conventional angle, the positive rotation-aimed operation teeth 9a1 can go over one convex of the ratchet teeth G. In this way, the swing width of the ratchet wrench handle A can be reduced.

Thus, the ratchet wrench handle A according to one embodiment of the present invention allows an operator, if it is as long as the ratchet wrench handle A′ disclosed in the aforesaid Prior Art Document 1, to work with only about half of the space that was required in order to go over one convex of the ratchet teeth 6′ in the conventional ratchet wrench handle.

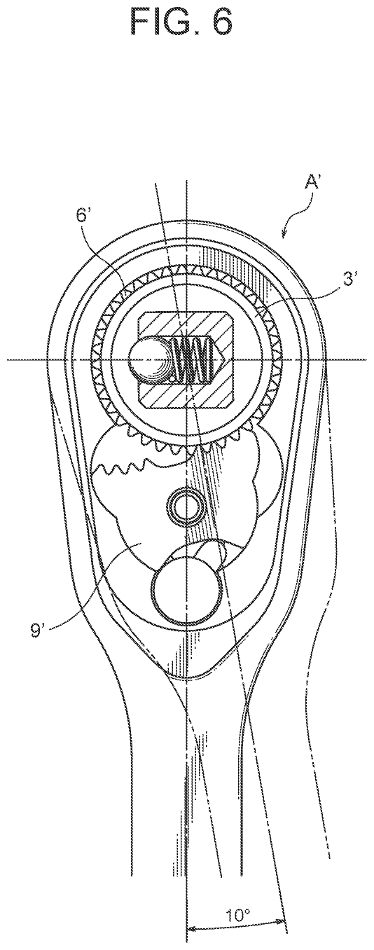

Therefore, compared with the ratchet wrench handle A′ disclosed by the aforesaid Prior Art Document 1, Japanese patent No. 5568273 shown in FIG. 6, the ratchet wrench handle A according to one embodiment of the present invention reduces the swing angle of the ratchet wrench handle A to half of the conventional swing angle, as shown in FIG. 7, thereby allowing the ratchet wrench handle to fulfill its function with a swing angle much smaller than that of the conventional one, and improving workability in a narrow space greatly.

When the operation handle 1 is rotated anti-clockwise, the claw member 9a forming a part of the operation piece 9 engages with the ratchet teeth 6 of the rotation member 3, and the claw member 9a and the receiving member 9b that form the operation piece 9 become integral as one body; thereby transmitting the rotation torque of the operation handle 1 to the rotation member 3. In this way, a tool can be rotated anti-clockwise according to the rotation of the operation handle 1.

### (When a Tool is Rotated in the Locked State at the Time of Positive Rotation)

When a tool is rotated by using the ratchet wrench handle A according to one embodiment of the present invention, the tool is mounted on the adapter t, and the operation handle 1 is rotated, in a locked state at the time of positive rotation as shown in FIG. 5, in the anti-clockwise direction of X. In this way, the rotation member 3 is rotated, thereby rotating the tool.

More particularly, because the operation piece 9 is composed of the two partial members, i.e., the claw member 9a and the receiving member 9b, when the operation handle 1 is rotated, in a locked state as shown in FIG. 5, in the anti-clockwise direction of X, the claw member's first positive rotation-aimed sloping face 9a3 (see FIG. 4A) and the receiving member's first positive rotation-aimed sloping face 9b1 (see FIG. 4B) are contacted under pressure with each other, and at the same time, the claw member's second positive rotation-aimed sloping face 9a7 (see FIG. 4A) and the receiving member's second positive rotation-aimed sloping face 9b5 (see FIG. 4B) are contacted under pressure with each other. At this time, because of the wedge effect of the claw member 9a, the claw member 9a and the receiving member 9b that form the operation piece 9 become integral as one body.

As mentioned above, the wedge effect of the claw member 9a makes the claw member 9a and the receiving member 9b that form the operation piece 9, become integral as one body, and thus, the rotation torque of the operation handle 1 is transmitted to the rotation member 3. In this way, the rotation member 3 can be rotated in the positive direction, thereby rotating the tool in the positive direction.

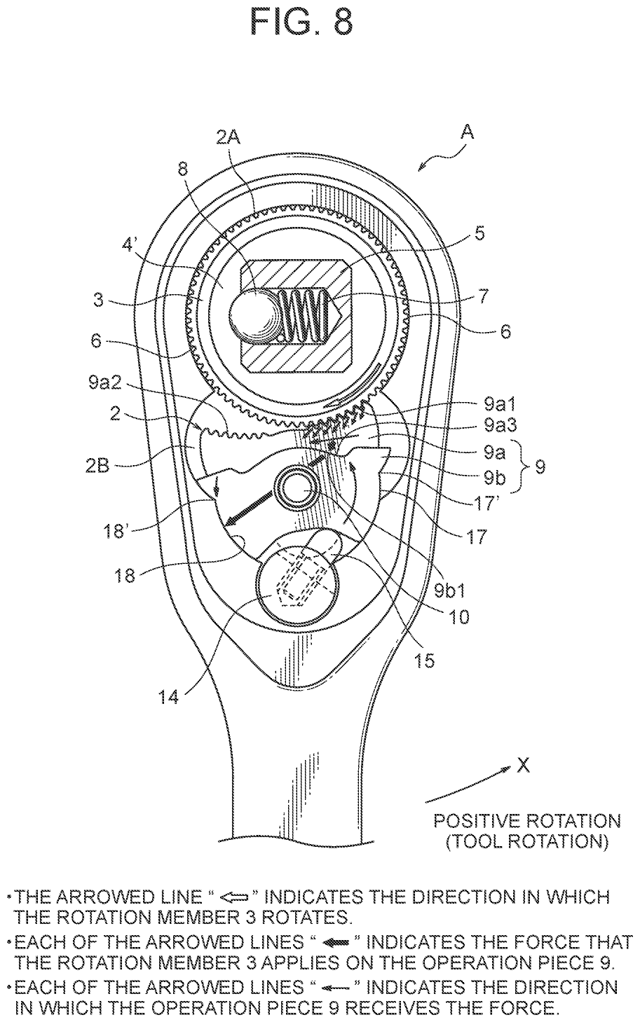

Moreover, because the operation piece 9 is composed of the two partial members, i.e., the claw member 9a and the receiving member 9b, when the operation handle 1 is rotated in the anti-clockwise direction of X in order to rotate the adapter t in the positive direction, the ratchet teeth 6 of the rotation member 3 and the positive rotation-aimed operation teeth 9a1 of the claw member 9a are engaged with each other as shown in FIG. 8, at which time the rotation torque is applied on the claw member 9a and the receiving member 9b in the clockwise direction, with the assembling bolt 10 as the center.

In this condition, the claw member's first positive rotation-aimed sloping face 9a3 and the receiving member's first positive rotation-aimed sloping face 9b1 are contacted with each other under pressure strongly, and at the same time, the claw member's second positive rotation-aimed sloping face 9a7 (see FIG. 4A) and the receiving member's second positive rotation-aimed sloping face 9b5 (see FIG. 4B) are contacted with each other under pressure strongly; thereby transmitting the rotation torque of the rotation member 3, by way of the claw member 9a and the receiving member 9b, to a pressure receiving edge 18 positioned lower than the assembling bolt 10, i.e., to a place close to the switch member 14 disposed on the opposite side of the ratchet wrench handle A from the operation handle 1, in the same way as the ratchet wrench handle A′ disclosed by the Prior Art Document 1, Japanese Patent No. 5568273.

### (Idling in the Reverse Direction in the Locked State at the Time of Positive Rotation)

As mentioned above, in the ratchet wrench handle A according to one embodiment of the present invention, the operation piece 9 is composed of the two partial members, i.e., the claw member 9a and the receiving member 9b. However, when the operation handle 1 is rotated in the reverse clockwise direction of Y, the claw member's reverse idling rotation-time pressing face 9a5 (see FIG. 4A) presses the receiving member's reverse idling rotation-time pressing face 9b3 (see FIG. 4B), thereby enabling the claw member 9a and the receiving member 9b to rotate as one body in the reverse direction of Y, whereby the claw member 9a and the receiving member 9b forming the operation piece 9 swing about the assembling bolt 10, and the ratchet teeth 6 of the rotation member 3 and the positive rotation-aimed operation teeth 9a1 of the claw member 9a slide over each other, which enables idling.

### (When a Tool is Rotated in the Locked State at the Time of Reverse Rotation, how is an Idling State Produced?)

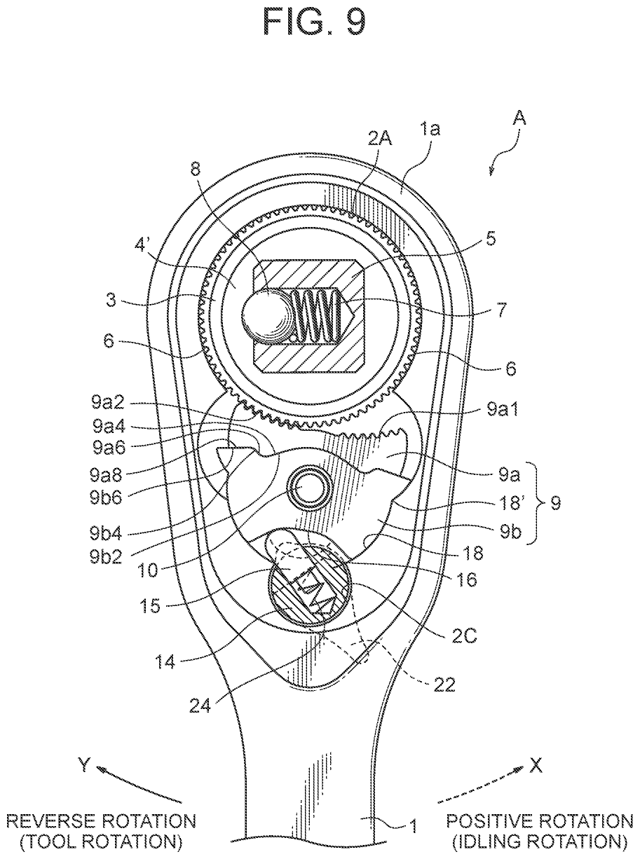

As shown by FIG. 9, when the pressing pin 15 of the switch member 14 is inclined to the left side that is opposite to the right side shown in FIG. 5, thereby switching the state of the ratchet wrench handle A to the locked state at the time of reverse rotation, the ratchet teeth 6 of the rotation member 3 and the reverse rotation-aimed operation teeth 9a2 (see FIG. 4A) engage with each other, as shown in FIG. 9.

In this condition, if the operation handle 1 is rotated in the clockwise direction of Y, even though the operation piece 9 is composed of the two partial members, i.e., the claw member 9a and the receiving member 9b, the claw member's first reverse rotation-aimed sloping face 9a4 (see FIG. 4A) and the receiving member's first reverse rotation-aimed sloping face 9b2 (see FIG. 4B) are contacted under pressure with each other, and at the same time, the claw member's second reverse rotation-aimed sloping face 9a8 (see FIG. 4A) and the receiving member's second reverse rotation-aimed sloping face 9b6 (see FIG. 4B) are contacted under pressure with each other. At this time, because of the wedge effect of the claw member 9a, the claw member 9a and the receiving member 9b that form the operation piece 9 become integral as one body.

As mentioned above, the wedge effect of the claw member 9a makes the claw member 9a and the receiving member 9b that form the operation piece 9, become integral as one body, and thus, the rotation torque of the operation handle 1 is transmitted to the rotation member 3. In this way, the rotation member 3 can be rotated in the reverse direction of Y, thereby rotating the tool in the reverse direction.

Furthermore, in this condition, if the operation handle 1 is rotated in the anti-clockwise direction of X, even though the operation piece 9 is composed of the two partial members, i.e., the claw member 9a and the receiving member 9b, the claw member's positive idling rotation-time pressing face 9a6 (see FIG. 4A) presses the receiving member's positive idling rotation-time pressing face 9b4 (see FIG. 4B), thereby allowing the claw member 9a and the receiving member 9b to rotate as one body in the reverse direction of X, whereby the claw member 9a and the receiving member 9b forming the operation piece 9 swing about the assembling bolt 10, and the ratchet teeth 6 of the rotation member 3 and the reverse rotation-aimed operation teeth 9a2 of the claw member 9a slide over each other, which enables idling (see FIG. 4A).

[symbol]

Summary of the Ratchet Wrench Handle A According to One Embodiment of the Present Invention

[symbol]

As described above, the ratchet wrench handle A according to one embodiment of the present invention comprises an operation piece 9 composed of two partial members, i.e., a claw member 9a provided, on its ratchet teeth 6 side, with positive rotation-aimed operation teeth 9a1 and reverse rotation-aimed operation teeth 9a2 that face and engage with the ratchet teeth 6; and a receiving member 9b rotatably mounted on a handle head 1a via an assembling bolt 10 in such a manner that the receiving member is provided with a cam edge to engage with the switch member and abuts the switch member side of the claw member by applying the side of the receiving member which is located opposite to the cam edge, over the assembling bolt located therebetween, wherein the claw member 9a is provided, on its switch member 14 side which is the side of the claw member 9a opposite the positive rotation-aimed operation teeth 9a1 and the reverse rotation-aimed operation teeth 9a2, with a claw member's first positive rotation-aimed sloping face 9a3 and a claw member's second positive rotation-aimed sloping face 9a7 that are opposite to the positive rotation-aimed operation teeth 9a1, and a claw member's first reverse rotation-aimed sloping face 9a4 and a claw member's second reverse rotation-aimed sloping face 9a8 that are opposite to the reverse rotation-aimed operation teeth 9a2, such that the claw member's first positive rotation-aimed sloping face 9a3, the claw member's second positive rotation-aimed sloping face 9a7, the claw member's first reverse rotation-aimed sloping face 9a4 and the claw member's second reverse rotation-aimed sloping face 9a8 are formed to slope down respectively in such a manner that the distance between the range of the claw member's first positive rotation-aimed sloping face 9a3 and the claw member's second positive rotation-aimed sloping face 9a7 and the range of the positive rotation-aimed operation teeth 9a1 is gradually increased as the sloping faces 9a3 and 9a7 go away from the center of the claw member 9a respectively, and the distance between the range of the claw member's first reverse rotation-aimed sloping face 9a4 and the claw member's second reverse rotation-aimed sloping face 9a8 and the range of the reverse rotation-aimed operation teeth 9a2 is gradually increased as the sloping faces 9a4 and 9a8 go away from the center of the claw member 9a respectively; and the receiving member 9b is provided, on its claw member 9a side, with a receiving member's first positive rotation-aimed sloping face 9b1 and a claw member's second positive rotation-aimed sloping face 9b5 that abut the claw member's first positive rotation-aimed sloping face 9a3 and the claw member's second positive rotation-aimed sloping face 9a7 respectively, and with a receiving member's first reverse rotation-aimed sloping face 9b2 and a receiving member's second reverse rotation-aimed sloping face 9b6 that abut the claw member's first reverse rotation-aimed sloping face 9a4 and the claw member's second reverse rotation-aimed sloping face 9a8 respectively.

In this condition, when the operation handle 1 is rotated in the anti-clockwise direction, with the positive rotation-aimed operation teeth 9a1 of the claw member 9a engaged with the ratchet teeth 6 of the rotation member 3 as shown in FIG. 5, etc., a wedge effect generated by the positive rotation-aimed operation teeth 9a1 of the claw member 9a, the claw member's first positive rotation-aimed sloping face 9a3 and the claw member's second positive rotation-aimed sloping face 9a7 makes the rotation member 3 stop its rotation, thereby rotating the adapter tin the anti-clockwise direction of X. On the other hand, when the operation handle 1 is rotated in the clockwise direction of Y, with the reverse rotation-aimed operation teeth 9a2 of the claw member 9a engaged with the ratchet teeth 6 of the rotation member 3 as shown in FIG. 9, a wedge effect generated by the reverse rotation-aimed operation teeth 9a2 of the claw member 9a, the claw member's first reverse rotation-aimed sloping face 9a4 and the claw member's second reverse rotation-aimed sloping face 9a8 makes the rotation member 3 stop its rotation, thereby rotating the adapter t in the clockwise direction of Y.

Furthermore, although the operation piece 9 is composed of the two partial members, i.e., the claw member 9a and the receiving member 9b, the torque at the time of rotating the tool is received, via the ratchet teeth 6 of the rotation member 3, by the claw member 9a and the receiving member 9b as one body, thereby transmitting the rotation torque to a pressure receiving edge 18 positioned lower than the assembling bolt 10, i.e., to a place close to the switch member 14 disposed on the opposite side of the ratchet wrench handle A from the operation handle 1, in the same way as the ratchet wrench handle A′ disclosed by the Prior Art Document 1, Japanese Patent No. 5568273.

Furthermore, because the operation piece 9 is composed of the two partial members, i.e., the claw member 9a and the receiving member 9b, the wedge effect generated by the positive rotation-aimed operation teeth 9a1 of the claw member 9a, the claw member's first positive rotation-aimed sloping face 9a3 and the claw member's second positive rotation-aimed sloping face 9a7 makes the rotation member 3 stop its rotation, thereby rotating the adapter t in the anti-clockwise direction of X; and the wedge effect generated by the reverse rotation-aimed operation teeth 9a2 of the claw member 9a, the claw member's first reverse rotation-aimed sloping face 9a4 and the claw member's second reverse rotation-aimed sloping face 9a8 also makes the rotation member 3 stop its rotation, thereby rotating the adapter t in the clockwise direction of Y. Thus, increase of the number of convexes of the ratchet teeth 6 and the number of convexes of the positive rotation-aimed operation teeth 9a1 and the reverse rotation-aimed operation teeth 9a2 does not cause slippage, and the reduced swing width of the handle provides a high efficiency and high quality ratchet wrench handle, improving workability.

In particular, in the ratchet wrench handle A according to one embodiment of the present invention, each of the angle α formed between the claw member's first positive rotation-aimed sloping face 9a3 and the claw member's reverse idling rotation-time pressing face 9a5, the angle formed between the claw member's first reverse rotation-aimed sloping face 9a4 and the claw member's positive idling rotation-time pressing face 9a6, the angle α′ formed between the receiving member's first positive rotation-aimed sloping face 9b1 and the receiving member's reverse idling rotation-time pressing face 9b3 and the angle β′ formed by the receiving member's first reverse rotation-aimed sloping face 9b2 and the receiving member's positive idling rotation-time pressing face 9b4, is an obtuse angle larger than 90 degrees and smaller than 180 degrees.

For that reason, when the ratchet teeth 6 of the rotation member 3 is engaged with the positive rotation-aimed operation teeth 9a1 or the reverse rotation-aimed operation teeth 9a2 of the claw member 9a, thereby transmitting the rotation torque of the rotation member 3 to the claw member 9a, the side of the claw member 9a not engaged with the ratchet teeth 6 of the rotation member 3 floats up a little, trying to separate from the receiving member 9b, which allows the positive rotation-aimed operation teeth 9a1 or the reverse rotation-aimed operation teeth 9a2 of the claw member 9a to engage with the ratchet teeth 6 of the rotation member 3 without fail. Therefore, increase of the number of convexes of the ratchet teeth 6, the positive rotation-aimed operation teeth 9a1 and the reverse rotation-aimed operation teeth 9a2 does not cause slippage easily, and the reduced swing width of the handle provides a high efficiency and high quality ratchet wrench handle, improving workability.

Furthermore, as particularly shown in FIGS. 4A and 4B, the ratchet wrench handle A according to one embodiment of the present invention has the following construction. The claw member 9a is further provided, on its switch member 14 side and at the same time, on its claw member's first positive rotation-aimed sloping face 9a3 side, with a claw member's reverse idling rotation-time pressing face 9a5 for pressing the receiving member 9b, thereby idling the claw member 9a and the receiving member 9b as one body, when the ratchet wrench handle A idles in the reverse direction. On the other hand, the claw member 9a is further provided, on its switch member 14 side and at the same time, on its claw member's first reverse rotation-aimed sloping face 9a4 side, with a claw member's positive idling rotation-time pressing face 9a6 for pressing the receiving member 9b, thereby idling the claw member 9a and the receiving member 9b as one body, when the ratchet wrench handle A idles in the positive direction. The receiving member 9b is further provided, on its claw member 9a side and at the same time, on its receiving member's first positive rotation-aimed sloping face 9b1 side, with a receiving member's reverse idling rotation-time pressing face 9b3 to be pressed by the claw member's reverse idling rotation-time pressing face 9a5, thereby idling the claw member 9a and the receiving member 9b as one body, when the ratchet wrench handle A idles in the reverse direction. On the other hand, the receiving member 9b is further provided, on its claw member 9a side and at the same time, on its receiving member's first reverse rotation-aimed sloping face 9b2 side, with a receiving member's positive idling rotation-time pressing face 9b4 to be pressed by the claw member's positive idling rotation-time pressing face 9a6, thereby idling the claw member 9a and the receiving member 9b as one body, when the ratchet wrench handle A idles in the positive direction.

For that reason, although the operation piece 9 of the ratchet wrench handle A according to one embodiment of the present invention is composed of the two partial members, i.e., the claw member 9a and the receiving member 9b, the claw member 9a and the receiving member 9b swing about the assembling bolt 10 as one body when the ratchet wrench handle A idles, whereby the ratchet teeth 6 of the rotation member 3 and either the positive rotation-aimed operation teeth 9a1 or the reverse rotation-aimed operation teeth 9a2 of the claw member 9a slide over each other, which provides idling. In this way, the idling function of the ratchet wrench handle A can be surely realized.

Furthermore, in the ratchet wrench handle A according to one embodiment of the present invention, the claw member's reverse rotation-time pressing face 9a5 is disposed, as a partition, between the claw member's first positive rotation-aimed sloping face 9a3 and the claw member's second positive rotation-aimed sloping face 9a7; the claw member's positive rotation-time pressing face 9a6 is disposed, as a partition, between the claw member's first reverse rotation-aimed sloping face 9a4 and the claw member's second reverse rotation-aimed sloping face 9a8; the receiving member's reverse idling-time pressing face 9b3 is disposed, as a partition, between the receiving member's first positive rotation-aimed sloping face 9b1 and the receiving member's second positive rotation-aimed sloping face 9b5; and the receiving member's positive idling-time pressing face 9b4 is disposed, as a partition, between the receiving member's first reverse rotation-aimed sloping face 9b2 and the receiving member's second reverse rotation-aimed sloping face 9b6. The inclination angle of the claw member's second positive rotation-aimed sloping face 9a7 located at an outer side of the claw member 9a is closer to the horizontal than that of the claw member's first positive rotation-aimed sloping face 9a3 located at an inner side of the claw member 9a; the inclination angle of the claw member's second reverse rotation-aimed sloping face 9a8 located at an outer side of the claw member 9a is closer to the horizontal than that of the claw member's first reverse rotation-aimed sloping face 9a4 located at an inner side of the claw member 9a; the inclination angle of the receiving member's second positive rotation-aimed sloping face 9b5 located at an outer side of the receiving member 9b is closer to the horizontal than that of the receiving member's first positive rotation-aimed sloping face 9b1 located at an inner side of the receiving member 9b; and the inclination angle of the receiving member's second reverse rotation-aimed sloping face 9b6 located at an outer side of the claw member 9a is closer to the horizonal than that of the receiving member's first reverse rotation-aimed sloping face 9b2 located at an inner side of the claw member 9a.

Therefore, in the ratchet wrench handle A according to one embodiment of the present invention, when the ratchet teeth 9a of the rotation member 3 is engaged with the positive rotation-aimed operation teeth 9a1 or the reverse rotation-aimed operation teeth 9a2 of the claw member 9a, thereby transmitting the rotation torque of the rotation member 3 to the claw member 9a, the side of the claw member 9a not engaged with the ratchet teeth 6 of the rotation member 3 floats up a little and separates from the receiving member 9b. In that case, even when the claw member's first positive rotation-aimed sloping face 9a3 and the claw member's first reverse rotation-aimed sloping face 9a4 that are located at inner sides of the claw member 9a try to separate from the receiving member's first positive rotation-aimed sloping face 9b1 and the receiving member's first reverse rotation-aimed sloping face 9b2 that are located at inner sides of the receiving member 9b, the claw member's second positive rotation-aimed sloping face 9a7 and the claw member's second reverse rotation-aimed sloping face 9a8 that are located at outer sides of the claw member 9a surely abut, respectively, the receiving member's second positive rotation-aimed sloping face 9b5 and the receiving member's second reverse rotation-aimed sloping face 9b6 that are located at outer sides of the claw member 9b, because each of the sloping faces 9a7, 9b5, 9a8 and 9b6 has an inclination angle closer to the horizontal than the inclination angle of those located at inner sides of the claw member 9a and the receiving member 9b. This enables transmitting the rotation torque, stress, etc. generated by the rotation member 3 from the claw member 9a to the receiving member 9b. Therefore, increase of the number of convexes of the ratchet teeth 6, the positive rotation-aimed operation teeth 9a1 and the reverse rotation-aimed operation teeth 9a2 does not cause slippage easily, and the reduced swing width of the handle provides a high efficiency and high quality ratchet wrench handle, improving workability.

1. A ratchet wrench handle comprising: a rotation member disposed at a handle head located at a distal end of an operation handle and provided with a portion for attaching an adapter, and an operation piece provided with positive rotation-aimed operation teeth and reverse rotation-aimed operation teeth, said rotation member being further provided with ratchet teeth continuously formed on a periphery of the rotation member to engage, through operating a switch member, with either one side chosen between the positive rotation-aimed operation teeth and the reverse rotation-aimed operation teeth provided on the operation piece, thereby to rotate the operation handle in the positive or reverse direction;
wherein the operation piece is composed of two partial members, i.e., a claw member provided, on the ratchet teeth side thereof, with the positive rotation-aimed operation teeth and the reverse rotation-aimed operation teeth that face and engage with the ratchet teeth, and a receiving member rotatably mounted on the handle head via an assembling bolt in such a manner that the receiving member is provided with a cam edge to engage with the switch member and abuts the switch member side of the claw member by applying the side of the receiving member which is located opposite to the cam edge, over the assembling bolt located therebetween; the claw member is further provided, on its switch member side which is the side of the claw member opposite the positive rotation-aimed operation teeth and the reverse rotation-aimed operation teeth, with a claw member's positive rotation-aimed sloping face and a claw member's reverse rotation-aimed sloping face that are opposite to the positive rotation-aimed operation teeth and the reverse rotation-aimed operation teeth respectively such that the claw member's positive rotation-aimed sloping face and the claw member's reverse rotation-aimed sloping face are formed to slope down in such a manner that the distance between the range of the claw member's positive rotation-aimed sloping face and the claw member's reverse rotation-aimed sloping face and the range of the positive rotation-aimed operation teeth and the reverse rotation-aimed operation teeth is gradually increased as those sloping faces go away from the center of the claw member respectively; and the receiving member is provided, on its claw member side, with a receiving member's positive rotation-aimed sloping face and a receiving member's reverse rotation-aimed sloping face that abut the claw member's positive rotation-aimed sloping face and the claw member's reverse rotation-aimed sloping face respectively when the operation handle is rotated in the positive and reverse directions.

2. The ratchet wrench handle according to claim 1, wherein the claw member is further provided, on its switch member side and at the same time, on its claw member's positive rotation-aimed sloping face side, with a claw member's reverse idling rotation-time pressing face for pressing the receiving member, thereby to idle the claw member and the receiving member as one body when the operation handle idles in the reverse direction, and is further provided, on its switch member side and at the same time, on its claw member's reverse rotation-aimed sloping face side, with a claw member's positive idling rotation-time pressing face for pressing the receiving member, thereby to idle the claw member and the receiving member as one body when the operation handle idles in the positive direction; and the receiving member is further provided, on its claw member side and at the same time, on its receiving member's positive rotation-aimed sloping face side, with a receiving member's reverse idling rotation-time pressing face to be pressed by the claw member's reverse idling rotation-time pressing face, thereby to idle the claw member and the receiving member as one body when the operation handle idles in the reverse direction, and is further provided, on its claw member side and at the same time, on its receiving member's reverse rotation-aimed sloping face side, with a receiving member's positive idling rotation-time pressing face to be pressed by the claw member's positive idling rotation-time pressing face, thereby to idle the claw member and the receiving member as one body when the operation handle idles in the positive direction.

3. The ratchet wrench handle according to claim 2, wherein an angle formed between the claw member's positive rotation-aimed sloping face and the claw member's reverse idling rotation-time pressing face, an angle formed between the claw member's reverse rotation-aimed sloping face and the claw member's positive idling rotation-time pressing face, an angle formed between the receiving member's positive rotation-aimed sloping face and the receiving member's reverse idling-time pressing face, and an angle formed between the receiving member's reverse rotation-aimed sloping face and the receiving member's positive rotation-time pressing face are each an obtuse angle larger than 90 degrees and smaller than 180 degrees.

4. The ratchet wrench handle according to claim 2, wherein the claw member's positive rotation-aimed sloping face is divided by the claw member's reverse idling rotation-time pressing face into two parts; the claw member's reverse rotation-aimed sloping face is divided by the claw member's positive idling rotation-time pressing face into two parts; the receiving member's positive rotation-aimed sloping face is divided by the receiving member's reverse idling rotation-time pressing face into two parts; and the receiving member's reverse rotation-aimed sloping face is divided by the receiving member's positive idling rotation-time pressing face into two parts; and the divided claw member's positive rotation-aimed sloping face, claw member's reverse rotation-aimed sloping face, receiving member's positive rotation-aimed sloping face and receiving member's reverse rotation-aimed sloping face are formed such that the sloping face located further outwardly than each of the claw member's reverse idling rotation-time pressing face, the claw member's positive idling rotation-time pressing face, the receiving member's reverse idling rotation-time pressing face and the receiving member's positive idling rotation-time pressing face has an inclination angle closer to the horizontal than the sloping face located inward from each of the aforesaid pressing faces.
